(19) United States
(12) Patent Application Publication
(10) Pub. No.: US 2009/0175131 A1
(43) Pub. Date: Jul. 9, 2009

(54) Alarm Clock Having Audio File Playback Capabilities

(76) Inventor: Michael J. Jackson, Greeneville, TN (US)

Correspondence Address: PITTS AND BRITTIAN P C, P O BOX 51295, KNOXVILLE, TN, 37950-1295, US

(21) Appl. No.: 12/351,585

(22) Filed: Jan. 9, 2009

Related U.S. Application Data
(60) Provisional application No. 61/019,862, filed on Jan. 9, 2008.

(51) Int. Cl. G04B 21/00; G04B 47/00; G04F 10/00

(52) U.S. Cl. 368/10; 368/274; 368/109

(57) ABSTRACT

Described is an alarm clock for playing selected audio files according to a time-based schedule. More specifically, the alarm clock is adapted to maintain a calendar and a clock and to store a plurality of audio files. The alarm clock assigns each audio file a corresponding date and time, and when an assigned date and time occurs, the alarm clock plays the corresponding audio file such that file is perceivable by a user.

### CROSS-REFERENCE TO RELATED APPLICATIONS

This application claims the benefit of U.S. Provisional Application No. 61/019,862, filed Jan. 9, 2008.

### STATEMENT REGARDING FEDERALLY SPONSORED RESEARCH OR DEVELOPMENT

Not Applicable

### BACKGROUND OF THE INVENTION

This invention pertains to an alarm clock for playing audio files. More particularly, this invention pertains to an alarm clock for playing selected audio files according to a time-based schedule.

### BRIEF SUMMARY OF THE INVENTION

In accordance with the various features of the present invention there is provided an alarm clock for playing selected audio files according to a time-based schedule. More specifically, the alarm clock includes a processor, a memory, an audio file delivery device, and a display, the processor being in electrical communication with the memory, the audio file delivery device, and the display. The processor maintains a calendar and a clock and displays the current date and time at the display. The memory is adapted to store a plurality of audio files, and the processor assigns a respective date and time to each of the audio files. The audio file delivery device is adapted to deliver the audio files such that a user can perceive the files. Stated differently, the audio file delivery device is adapted to play the audio files such that the user can hear them. When an assigned date and time occur, the processor activates the audio file delivery device such that it delivers the audio file corresponding to the current date and time. As a result, the alarm clock can be programmed to, for example, play a different one of the plurality of audio files at a given time each evening. For example, when the plurality of audio files includes an audio-formatted book and each of the plurality of audio files is a chapter of the book, the alarm clock can be programmed to play the next sequential chapter each evening.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a block diagram of one embodiment of the alarm clock in accordance with the various features of the present invention;

FIG. 2 illustrates one embodiment of the alarm clock in accordance with the various features of the present invention; and

FIG. 3 illustrates one embodiment of the back side of the alarm clock of FIG. 2.

### DETAILED DESCRIPTION OF THE INVENTION

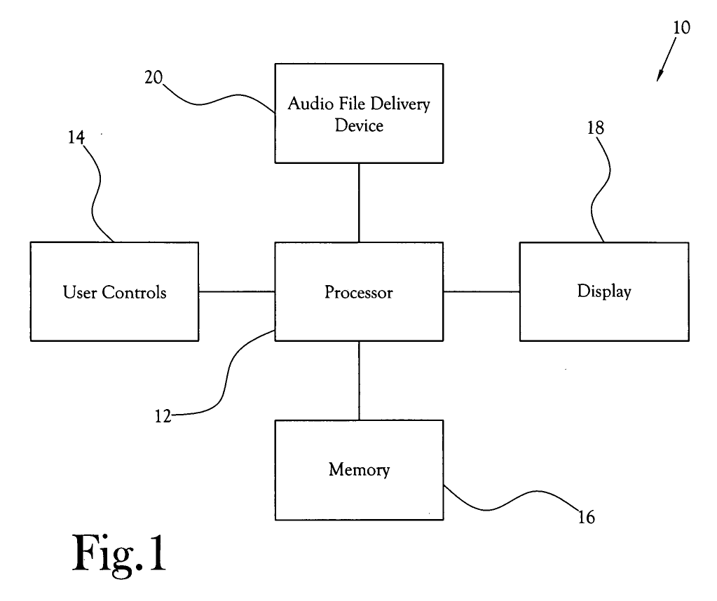

The present invention provides an alarm clock for playing selected audio files according to a time-based schedule. More specifically, the alarm clock is adapted to maintain a calendar and a clock and to store a plurality of audio files. The alarm clock assigns each audio file a corresponding date and time, and when an assigned date and time occurs, the alarm clock plays the corresponding audio file such that file is perceivable by a user. A block diagram of one embodiment of the alarm clock constructed in accordance with the various features of the present invention is illustrated generally at 10 in FIG. 1.

In the illustrated embodiment, the alarm clock 10 includes a processor 12, user controls 14, memory 16, a display 18, and an audio file delivery device 20, the processor 12 being in electrical communication with the user controls 14, the memory 16, the display 18, and the audio file delivery device 20. The user programs the current date and time into the processor 12 by way of the user controls 14, and the processor maintains the date and time based on the user's settings. The memory 16 is adapted to store a plurality of audio files. The memory 16 can be integrated within the alarm clock 10 or can be an external memory, such as a memory card. For example, in one embodiment, when the memory 16 is integrated, the alarm clock 10 is adapted to interface with a computer to download the audio files to the memory 16. In another embodiment, when the memory 16 is integrated, the audio files are programmed into the memory 16 at the time of manufacture. When the memory 16 is external, the alarm clock 10 is adapted to establish electrical communication between the processor 12 and the memory 16.

The audio file delivery device 20 delivers, or plays, the audio files such that the files are audibly perceivable by the user. The audio file delivery device 20 can be any electroacoustic device capable of delivering the audio files. For example, in one embodiment, the audio file delivery device 20 is a speaker.

The processor 12 assigns a date and time to each of the plurality of audio files. In one embodiment, the processor 12 automatically assigns the dates and times. In another embodiment, the user manually assigns a date and time to each audio file using the user controls 14. Upon the occurrence of an assigned date and time, the corresponding audio file is played by way of the audio file delivery device 20 such that the audio file is perceivable by the user. In one embodiment, the audio files are assigned such that the files are played in a sequential order. For example, when the plurality of audio files is an audio-formatted book and each of the audio files is a chapter of the book, the audio files are assigned respective dates and times such that the chapters are played sequentially. For example, in one embodiment, the audio files are assigned dates and times such that each evening at 6:00, an audio file is played. As a result, in one embodiment, each evening the next chapter of a book is played.

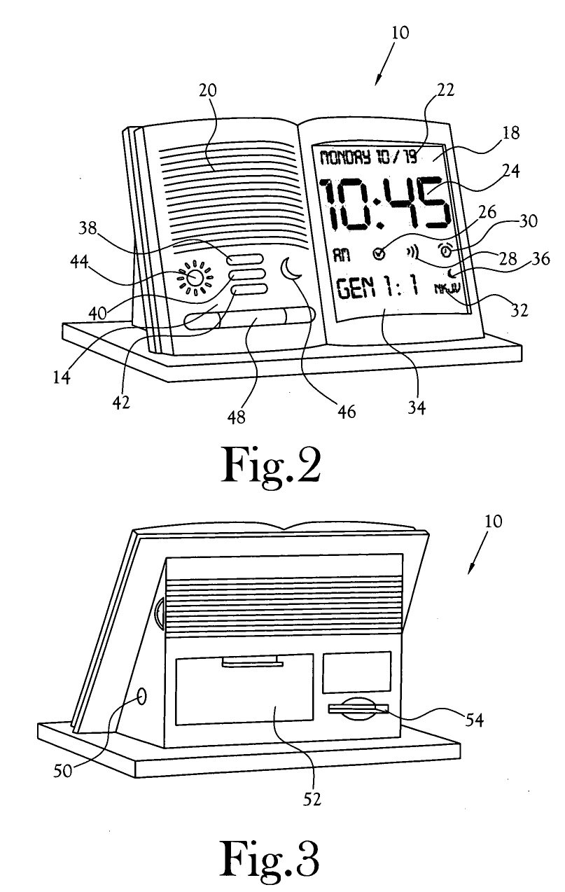

FIG. 2 illustrates one embodiment of the alarm clock 10 in accordance with the various features of the present invention. In the illustrated embodiment, the alarm clock 10 includes the display 18, the user controls 14, and the audio file delivery device 20. Also, in the illustrated embodiment, the display 18 displays the current date at 22 and the current time at 24. As previously discussed, the current date and time are maintained by the processor 12. The display 18 also displays an audio file delivery indicator 26, an alarm enabled indicator 28, an alarm activated indicator 30, an audio file plurality title indicator 32, an audio file title indicator 34, and a next delivery time indicator 36. The audio file delivery indicator 26 indicates whether the most recently initiated audio file playback has been completed. For example, in the illustrated embodiment, the audio file delivery indicator 26 displays a check mark when the most recently delivered audio file has been delivered in its entirety.

In the illustrated embodiment, the alarm clock 10 is adapted to deliver a time-based audible alarm, such as a beep or chime, which is designed to, for example, awake a sleeping user. The time at which the alarm is delivered is programmed by the user using the user controls 14. The alarm enabled indicator 28 indicates whether the programmed alarm is enabled or disabled. When the alarm is enabled, the alarm clock 10 delivers the alarm upon the occurrence of the programmed time, and when the audible alarm is disabled, the alarm clock 10 does not deliver the alarm. In the illustrated embodiment, the alarm enabled indicator 28 displays a sound wave symbol when the alarm is enabled. The alarm activated indicator 30 indicates whether the audible alarm is activated. Stated differently, when the alarm clock 10 is delivering the alarm, the alarm activated indicator 30 displays a symbol, which, in the illustrated embodiment, is the face of a clock.

The audio file plurality indicator 32 indicates the title of the collective plurality of audio files currently being delivered. For example, when the collective plurality of audio files is an audio-formatted book, the title of the plurality of audio files is the title of the book. In the illustrated embodiment, the plurality of audio files is an audio-formatted New King James Version of the Bible. Consequently, the audio file plurality title indicator 32 displays the acronym “NKJV”, an abbreviated title for the New King James Version of the Bible. The audio file title indicator 34 indicates the title of the audio file currently being delivered or most recently delivered. For example, when the audio file is an audio-formatted chapter of a book, the title of the audio file is the title of the chapter or the chapter number. In the illustrated embodiment, the currently delivered audio file is Genesis 1:1. Consequently, the audio file title indicator 34 displays “GEN 1:1”, an abbreviated title for the chapter and verse Genesis 1:1. It should be noted that the plurality of audio files need not be an audio-formatted book to remain within the scope or spirit of the present invention. For example, in one embodiment, the plurality of audio files is a series of lectures, whereby each lecture in the series is one of the plurality of audio files.

The next delivery time indicator 36 indicates when the next audio file will be delivered. For example, in the illustrated embodiment, the next delivery time indicator 36 displays a moon when the next audio file will be delivered in the evening and displays a sun when the next audio file will be delivered in the morning.

In accordance with the above discussion, the user controls 14 enable the user to communicate with the alarm clock 10. In the illustrated embodiment, the user controls 14 include an alarm switch 38, a clock switch 40, a mode switch 42, a morning audio file switch 44, an evening audio file switch 46, and navigation switches 48. In the illustrated embodiment, the alarm switch 38 is a pressable button for enabling and disabling the alarm and, in conjunction with the navigation switches 48, for programming the time at which the alarm clock 10 delivers the alarm. In the illustrated embodiment, the clock switch 40 is a pressable button used in conjunction with the navigation switches 48 for setting the current time and date as maintained by the processor 12. In the illustrated embodiment, the mode switch 42 is a pressable button for activating and deactivating the audio file delivery feature of the present invention. Stated differently, when the user desires the alarm clock 10 to deliver the audio files as discussed above, the user activates the feature using the mode switch 42. When the user desires the alarm clock 10 to not deliver the audio files, the user deactivates the feature.

In the illustrated embodiment, the morning audio file switch 44 is a sun-shaped pressable button, which, when operated, causes the display 18 to show the date and time corresponding to the next audio file to be delivered in the morning, and, in one embodiment, causes the alarm clock 10 to play the audio file upon such operation. Similarly, in the illustrated embodiment, the evening audio file switch 46 is a moon-shaped pressable button, which, when operated, causes the display 18 to show the date and time corresponding to the next audio file to be delivered in the evening, and, in one embodiment, causes the alarm clock 10 to play the audio file upon such operation. In the illustrated embodiment, the navigation switches 48 are pressable buttons for navigating various programming options and audio files and for accepting the desired settings.

FIG. 3 illustrates one embodiment of the back side of the alarm clock 10 in accordance with the various features of the present invention. In the illustrated embodiment, the alarm clock 10 includes a power jack 50, a battery compartment 52, and an external memory drive 54. The power jack 50 is compatible with a power adapter (not shown) such that the operating power of the alarm clock 10 is drawn from a standard electrical outlet, such as a 120 volt outlet. The battery compartment 52 receives batteries, which serve as a back-up power source for the alarm clock 10. More specifically, in the event the operating power drawn from the standard electrical outlet is disrupted by, for example a power outage, the batteries provide operating power to the processor 12 such that the date, time, and other settings are maintained during the disruption. The external memory drive 54 is adapted to receive an external memory 16. Storing the plurality of audio files at the external memory 16 permits the user to conveniently select from and alternate among various pluralities of audio files.

From the foregoing description, those skilled in the art will recognize that an alarm clock for playing audio files offering advantages over the prior art has been provided. More specifically, the alarm clock is adapted to maintain a calendar and a clock and to store a plurality of audio files. The alarm clock assigns each audio file a corresponding date and time, and when an assigned date and time occurs, the alarm clock plays the corresponding audio file such that file is perceivable by a user.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants general inventive concept.

Having thus described the aforementioned invention, what is claimed is:

1. An alarm clock comprising:
a memory adapted to store a plurality of audio files;
a processor adapted to be in electrical communication with said memory, said processor adapted to maintain a calendar and a clock, said processor assigning a respective date and time to each of the plurality of audio files;
a display in electrical communication with said processor, said display adapted to display the current date and time as kept by said processor; and
an audio file delivery device in electrical communication with said processor, said audio file delivery device adapted to deliver each of the plurality of audio files such that the audio file is perceivable by a user, said processor activates said audio file delivery device such that said audio delivery device delivers one of the plurality of audio files upon the occurrence of the respective date and time assigned to the audio file.

2. The alarm clock of claim 1 wherein said memory is integrated within said alarm clock.

3. The alarm clock of claim 1 wherein said memory is external to said alarm clock.

4. The alarm clock of claim 3 wherein said memory is an external memory card.

5. The alarm clock of claim 4 further comprising an external memory card drive adapted to receive the external memory card such that the external memory card is in electrical communication with said processor when received.

6. The alarm clock of claim 1 wherein the plurality of audio files includes an audio-formatted book.

7. The alarm clock of claim 6 wherein each of the plurality of audio files is an audio-formatted chapter of the audio-formatted book.

8. An alarm clock comprising:
memory adapted to store a plurality of audio files;
a processor adapted to be in electrical communication with said memory, said processor adapted to maintain a calendar and a clock, said processor assigning a respective date and time to each of the plurality of audio files;
a display in electrical communication with said processor, said display adapted to display the current date and time as kept by said processor;
user controls in electrical communication with said processor, said user controls enabling a user to adjust the various settings associated with said alarm clock; and
an audio file delivery device in electrical communication with said processor, said audio file delivery device adapted to deliver each of the plurality of audio files such that the audio file is perceivable by a user, said processor activates said audio file delivery device such that said audio delivery device delivers one of the plurality of audio files upon the occurrence of the respective date and time assigned to the audio file.

9. The alarm clock of claim 8 wherein said memory is integrated within said alarm clock.

10. The alarm clock of claim 8 wherein said memory is external to said alarm clock.

11. The alarm clock of claim 8 wherein the plurality of audio files includes an audio-formatted book.

12. The alarm clock of claim 11 wherein each of the plurality of audio files is an audio-formatted chapter of the audio-formatted book.

13. The alarm clock of claim 11 wherein said user controls include an audio file switch, the audio file switch causing the alarm clock to deliver a selected one of the plurality of audio files when operated.
